(19) United States
(12) Patent Application Publication
(10) Pub. No.: US 2025/0042115 A1
(43) Pub. Date: Feb. 6, 2025

(54) METHOD AND APPARATUS FOR RETREAD SIDEWALL MACHINING

(71) Applicant: BRIDGESTONE BANDAG, LLC, Nashville, TN (US)

(72) Inventors: Troy A. Kost, Muscatine, IA (US); Alexander G. Tomtschik, Muscatine, IA (US)

(73) Assignee: BRIDGESTONE BANDAG, LLC, Nashville, TN (US)

(21) Appl. No.: 18/709,412

(22) PCT Filed: Oct. 25, 2022
(86) PCT No.: PCT/US2022/078620

§ 371 Date: May 10, 2024

Related U.S. Application Data
(60) Provisional application No. 63/281,442, filed on Nov. 19, 2021.

(51) Int. Cl. B29D 30/54; B29D 30/72

(52) U.S. Cl. CPC B29D 30/54; B29D 30/72; B29D 2030/544

(57) ABSTRACT

A method of forming a retreaded tire is provided. The method includes coupling a retread element to a tire casing to form a retreaded tire having a tread surface and machining a sidewall of the retreaded tire. The sidewall of the retreaded tire is then machined, where machining the sidewall of the retreaded tire includes removing a portion of the sidewall to form a concave fillet in the sidewall. The concave fillet is positioned radially inward from the tread surface.

### BACKGROUND

Retreaded tires provide an economical way to gain additional use from tire casings after the original tread or retread has become worn. According to some methods of retreading, sometimes referred to as cold process retreading, worn tire tread on a used tire is removed to create a buffed, generally smooth treadless surface about the circumference of the tire casing to which a new layer of tread may be bonded.

The tire casing may be inspected for damage, some of which may be skived and filled with a repair gum while others may be severe enough to warrant rejection of the casing. After completion of the skiving process, the buffed surface may be sprayed with a tire cement that provides a tacky surface for application of bonding material and new tread. Next, a layer of cushion gum may be applied to the back, i.e., the inside surface of a new layer of tread, or alternatively, the layer of cushion gum may be applied directly to the tacky surface on the tire casing. Conventionally, the cushion gum is a layer of uncured rubber material. The cushion gum and tread may be applied in combination about the circumference of the tire casing to create a retreaded tire assembly for curing. Alternatively, a length of tire tread may be wrapped around the tire casing with the cushion gum already applied. The cushion gum may form the bond between the tread and the tire casing during curing.

Following assembly of the tire casing, cement, cushion gum and tread, the overall retreaded tire assembly may be placed within a flexible rubber envelope. An airtight seal may be created between the envelope and the bead of the tire. The entire envelope tire assembly may be placed within a curing chamber and subjected to a vulcanization process that binds the materials together.

### SUMMARY

A vulcanization process such as that noted above may result in discontinuities including groove seams, groove cracks, flash, and/or rough surfaces on the cured retreaded tire. The groove seams and groove cracks may lead to crack propagation and separation of the tread element through the use of the retreaded tire.

At least one embodiment relates to a method of forming a retreaded tire. The method includes coupling a retread element to a tire casing to form a retreaded tire having a tread surface and machining a sidewall of the retreaded tire. Machining the sidewall of the retreaded tire includes removing a portion of the sidewall to form a concave fillet in the sidewall. The concave fillet is positioned radially inward from the tread surface.

Another embodiment relates to a cutting tool assembly. The cutting tool assembly includes a chassis and a tool coupled to the chassis. The chassis includes a main body, a first flange, and a second flange. The first flange is coupled to the main body and extends away from the main body in a first direction. The first flange also includes a first roller configured for engaging a tread surface of a tire. The second flange is coupled to the main body and extends in a second direction different from the first direction. The second flange includes a second roller configured for engaging a sidewall of the tire. The tool includes a handle, an actuator, and a grinding bit operably coupled to the actuator. The grinding bit is configured to remove a portion of the sidewall of the tire to form a concave fillet.

Another embodiment relates to a method of forming a retreaded tire. The method includes providing a tire casing having a casing profile; providing a retread element having a back side and a front side, the front side having a tread surface; aligning the retread element on the tire casing to produce a retreaded tire assembly; curing the retreaded tire assembly such that the back side is coupled to the tire casing to form a retreaded tire; and machining a sidewall of the retreaded tire to remove a portion of the retreaded tire to form a concave fillet contiguously and circumferentially about the sidewall of the retreaded tire.

### BRIEF DESCRIPTION OF THE DRAWINGS

The disclosure will become more fully understood from the following detailed description, taken in conjunction with the accompanying Figures, wherein like reference numerals refer to like elements, in which:

FIG. 1 is a front, cross-sectional view of a tire casing, according to an example embodiment,

FIG. 2 is a front, cross-sectional view of a retread element, according to an example embodiment,

FIG. 3 is a front, cross-sectional view of a retreaded tire, according to an example embodiment, having the tire casing of FIG. 1 and the retread element of FIG. 2,

FIG. 4 is a side perspective view of the retreaded tire of FIG. 3,

FIG. 5 is a side perspective view of the retreaded tire of FIG. 3, according to another example embodiment,

FIG. 6 is a side perspective view of the retreaded tire of FIG. 3 having a concave fillet, according to an example embodiment,

FIG. 7 is a perspective view of a grinding bit, according to an example embodiment;

FIG. 8 is a front cross-sectional view of the retreaded tire of FIG. 6,

FIG. 9 is a front cross-sectional view of the retreaded tire of FIG. 6, according to another example embodiment,

FIG. 10 is a front cross-sectional view of the retreaded tire of FIG. 6, according to another example embodiment.

FIG. 11 is a front cross-sectional view of the retreaded tire of FIG. 6, according to yet another example embodiment,

FIG. 12 is a front cross-sectional view of the retreaded tire of FIG. 6, according to yet another example embodiment,

FIG. 13 is a perspective view of a retread tire mount system, according to an example embodiment,

FIG. 14 is a perspective view of a cutting tool assembly, according to an example embodiment,

FIG. 15 is an exploded view of the cutting tool assembly of FIG. 14,

FIG. 16 is perspective view of a cutting tool assembly having the tire mount system of FIG. 13, according to another example embodiment,

FIG. 17 is a rear perspective view of a portion of the cutting tool assembly of FIG. 16,

FIG. 18 is a front perspective view of the portion of the cutting tool assembly of FIG. 17,

FIG. 19 is a front perspective view of the portion of the cutting tool assembly of FIG. 18, according to another example embodiment,

FIG. 20 is a flow chart of a method of cutting a retreaded tire, according to an example embodiment, and

FIG. 21 is a flow chart of a method of cutting a retreaded tire, according to another example embodiment.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of cutting a retreaded tire. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Tires are used in various applications and under a variety of circumstances. Some tires may be designed to withstand the forces of a landing aircraft. Some tires may be designed to provide extra grip on surfaces covered in snow and ice. Some tires may be manufactured to be more suited to be repairable and retreaded.

Retreaded tires are used in applications ranging from aircraft landing gear to long-haul tractor-trailers. Retreaded tires are used all over the world. As a result, a retreaded tire may be easily identifiable due to deformities that exist on the retreaded tire sidewalls from the previous use such as tire wear, scuffs, or scratches, or deformities created from the curing process, such as groove seams, groove cracking, and cushion gum flash. These deformities affect the tire's appearance and may affect the structural integrity of the retreaded tire. For example, groove cracks and groove seams may increase the risk of crack propagation along the sidewalls of the retreaded tire due to stress, which may lead to separation between the tread element to and the tire casing.

In contrast, various embodiments of the methods and systems for retreaded tire sidewall cutting may provide one or more benefits. For example, the removal of sidewall deformities may remove stress risers that are created from flash and bond seams, which may in turn increase the fatigue life of the retreaded tire. Further, removal of sidewall deformities may improve the appearance of the retreaded tire.

### II. Terms

As used herein, the term “precured” refers to a material that is cured. Conversely, “uncured” refers to materials that are in their raw form and have not been cured. For example, curing an uncured material results in a cured or precured material.

As used herein, the term “precured tire tread” refers to a tire tread or build-up (e.g., precured product having no tread pattern thereon; blank; slick) that is separate from (e.g., not cured to) a tire casing. After a precured tire tread has been cured to a tire casing, the precured tire tread becomes a tire tread, and the combination of the precured tread cured to the tire casing forms a tire. The precured tire tread may take the form of a strip, oval, circle, ring, or similar shape.

As used herein, the term “retread element” may refer to a precured tire tread or a precured tire tread including materials and features such as, but not limited to, studs, reinforcing fabrics, Kevlar, nylon, cords, and similar features and materials.

As used herein, the term “retreaded tire assembly” refers to a precured tire assembly applied to a tire casing with an uncured adhesive interposed between the mating surfaces. The retreaded tire assembly may be ready to be positioned within an envelope for curing. After a retreaded tire assembly has been cured, it becomes a tire.

As described herein, the terms “axial” and “axially” refers to the direction parallel the axis of rotation of the tire.

As described here, the terms “circumferential” and “circumferentially” refer to the direction extending along the perimeter of the surface of the tire perpendicular to an axial direction.

As described herein, the terms “radial” and “radially” refer to the direction toward or away from the axis of rotation of the tire.

### III. Overview of Method and Apparatus for Cutting a Retreaded Tire

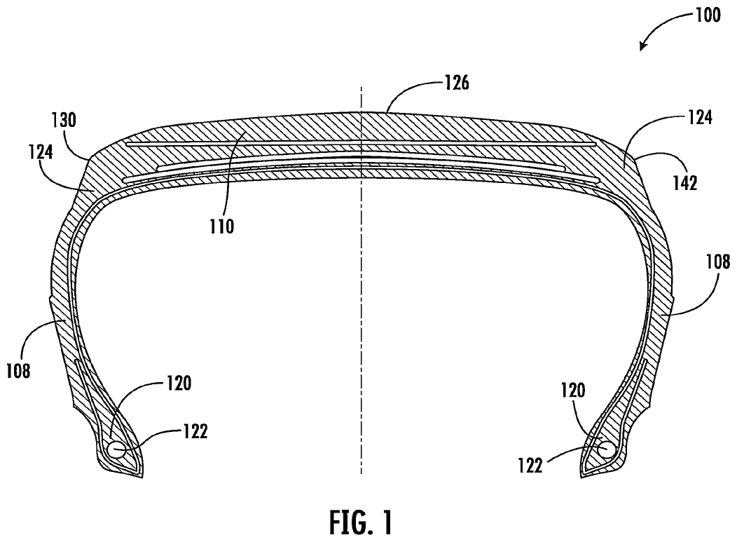

Referring to FIG. 1, a front, cross-sectional view of a tire casing (e.g., tire carcass, etc.,) 100 is shown, according to an example embodiment. After the tire tread of a tire wears beyond a certain limit, the tire must either be discarded, re-grooved, or retreaded before it can be used on a vehicle for which it was designed. In cold process retreading, what remains of the tire tread is removed from the tire casing 100 by a buffing machine through a buffing operation. During the buffing operation, the tire tread is ground away from the tire casing 100, leaving the buffed tread mounting surface 126 (e.g., mounting surface, mating surface, bonding surface, curing surface, etc.) on the tire casing 100. The buffed tread mounting surface 126 extends circumferentially about the tire casing 100 and extends axially across the outer wall 110 until it terminates at the shoulder areas 124. The buffed tread mounting surface 126 exhibits a curvature between the shoulder areas 124. In some embodiments, the buffed tread mounting surface 126 is buffed to a slightly rounded (e.g., toroidal) radius extending between the shoulder areas 124. The tire casing 100 may be a radial tire or a bias ply tire.

The tire casing 100 includes a pair of sidewalls 108 bounded by a generally radial outer wall 110 (e.g., crown, etc.) that extends between the sidewalls 108. Each of the sidewalls 108 extends radially inward from the outer wall 110 and terminates at a bead area 120 structured for mounting on a tire rim. The bead area 120 may be designed in a variety of configurations depending on, for example, tire type, tire size, or rim configuration. The bead area 120 includes a bead 122 bead that has metal strands or wires to improve the strength of the bead area 120.

The sidewalls 108 may include multiple layers, such as a rubber layer, a radial ply, and an inner liner, which cooperate to provide strong and flexible sidewalls 108. The sidewalls 108 are joined to the outer wall 110 and the tire tread 106 through a pair of shoulder areas 124. The shoulder areas 124 are contiguous with the sidewalls 108 and the outer wall 110. In some embodiments, the shoulder areas 124 are contiguous with the tire tread 106.

In some embodiments, a portion of the tire tread is left behind on the tire casing 100, such as if the user would like to increase a thickness of the outer wall 110 before applying a retread element, as described herein, to the tire casing 100. The tire tread has been removed, leaving behind (e.g., exposing, revealing, etc.) the buffed tread mounting surface 126. After the tire tread is removed and the buffed tread mounting surface 126 is exposed, a process called skiving and filling may be performed on the tire casing 100. Skiving and filling is the removal of and filling of deformities (e.g., damaged material, undesired material, scuffs, scratches, holes, nicks, punctures, tears, etc.) present in the tire casing 100 prior to making a repair or performing a retread operation. Often, the tire casing 100 accumulates deformities due to bits or other sharp objects the tire comes in contact with during use. The deformities are first ground smooth by an appropriate cutting tool (e.g., sidewall buffer, wire brush, etc.), and then filled with repair gum (e.g., uncured rubber material, etc.). The injured areas may be filled to the level of the buffed tread mounting surface 126 (e.g., such that the buffed tread mounting surface 126 remains smooth) to avoid air pockets between the buffed tread mounting surface 126 and the later applied retread element. Trapped air between the buffed tread mounting surface 126 and the retread element, as described herein, can have negative effects on the longevity of a typical retreaded tire, as described herein.

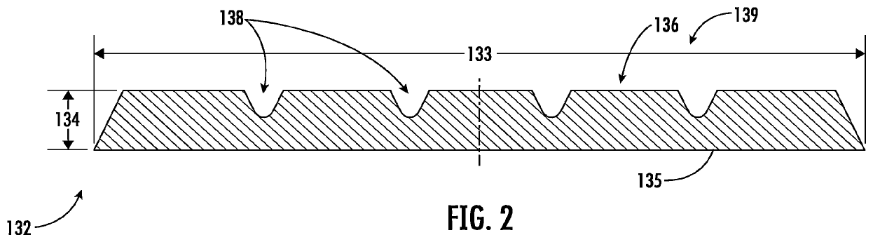

After the buffing, skiving, and filling operations, a retread element (e.g., precured tire tread, etc.) 132 is coupled to the tire casing 100. Referring to FIG. 2, a front, cross-sectional view of a retread element 132 is shown. The retread element 132 (e.g., tread band, etc.) may be formed from rubber, natural rubber, synthetic rubber, and various polymers and compounding ingredients, such as carbon black, silica, anti-degradants, and zinc oxide. The retread element 132 may be formed in a strip having a tread width 133 corresponding to a width of the buffed tread mounting surface 126 between the shoulder areas 124. The tread width 133 is in a range of approximately (e.g., within 5% of being, etc.) 6 inches (in) and approximately 14 inches, inclusive (e.g., about 5.7 in., about 6 in., about 7 in., about 8 in., about 9 in., about 10 in., about 11 in., about 12 in., about 13 in., about 14 in., about 14.7 in., etc.). Additionally, the retread element 132 has a tread thickness (e.g., element thickness or a tread span that is an extent of the retread element in a thickness direction) 134. The tread thickness 134 is in a range of approximately 0.3 inches and approximately 2 inches, inclusive (e.g., about 0.285 in., about 0.3 in., about 0.5 in., about 0.75 in., about 1 in., about 1.25 in., about 1.5 in., about 1.75 in., about 2 in., about 2.1 in., etc.). The retread element 132 includes a retread element back side 135 (e.g., generally planar mounting surface, continuous surface, mating surface, binding surface, etc.). The retread element 132 includes a retread element front side 136 (e.g. e.g., generally planar opposing surface, road-contacting surface, tread surface, etc.), which is opposite of the retread element back side 135. The retread element front side 136 is configured to engage with a road surface and includes a plurality of tread grooves 138 configured to channel water and provide added traction during certain road and weather conditions. In some embodiments, the retread element front side 136 includes a tread pattern 139 (e.g., a tread design, a series of treads, a tread pattern repetition, etc.). The tread pattern 139 may include a plurality of lugs, grooves, cuts, sipes, sipe cuts, and similar features.

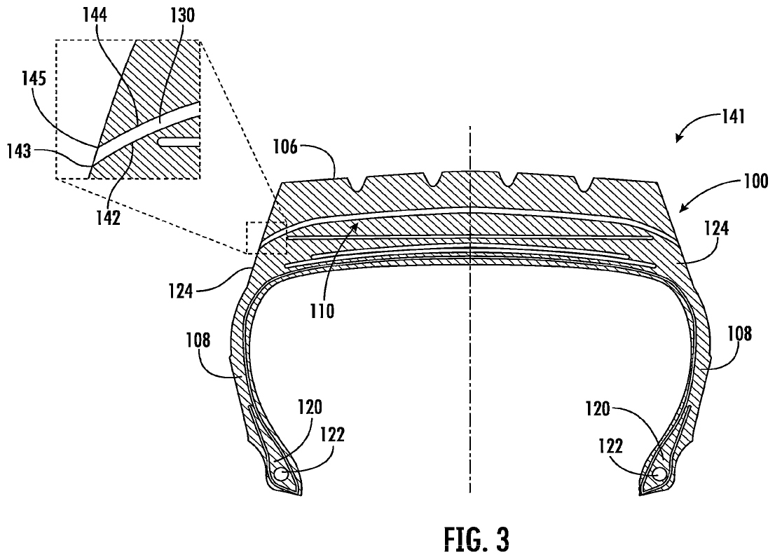

Referring now to FIG. 3, a front, cross-sectional view of a retreaded tire having the tire casing 100 is shown. The retread element 132 is coupled to the tire casing 100 using an adhesive 130 (e.g., cushion gum, uncured gum, uncured adhesive, polyurethane adhesive, rubber cement, liquid adhesive, etc.,). The adhesive 130 is extruded freely on to the buffed tread mounting surface 126 after the buffing, skiving, and filling operations. In some embodiments, the adhesive 130 is cushion gum. Specifically, after the tire is buffed, the adhesive 130 is extruded on to the buffed tread mounting surface 126 and the retread element back side 135 is positioned on the adhesive 130 such that the retread element back side 135 extends between the shoulder areas 124 of the tire casing 100. Accordingly, a retreaded tire assembly is formed. The retreaded tire assembly is then placed in a pressure chamber and the adhesive 130 is cured. In some embodiments, the retreaded tire assembly is placed within a curing envelope and placed within a curing chamber (e.g., autoclave, pressure vessel, etc.). The temperature and/or pressure of the curing chamber is controlled such that the retread element 132 conforms to the tire casing 100. After the retreaded tire assembly is cured, a retreaded tire 141 is formed. The retreaded tire 141 includes sidewalls 108. Portions of the sidewalls 108 are formed by the adhesive 130 and the retread element 132. In some embodiments, the sidewalls 108 extend from the retread element front side 136 to the bead area 120.

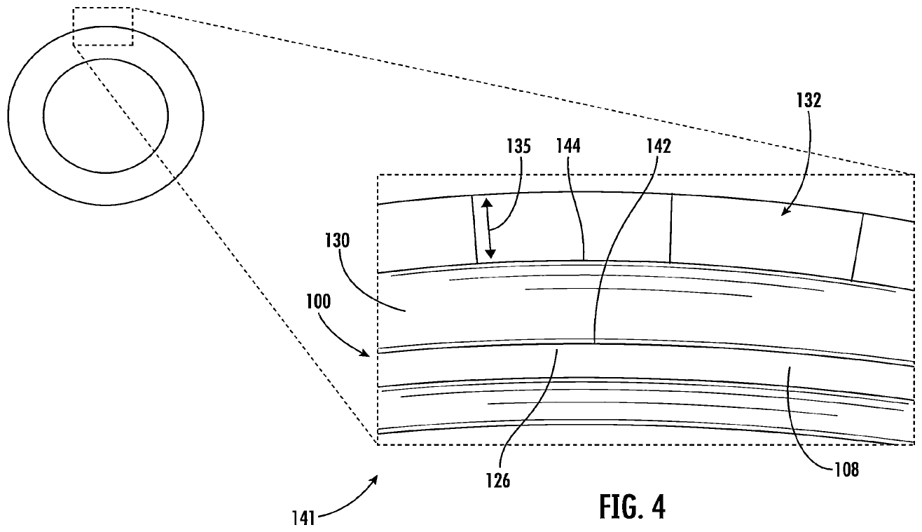

Referring now to FIG. 4, a side perspective view of the retreaded tire 141 is shown. In some embodiments, the adhesive 130 is extruded onto the buffed tread mounting surface 126 such that an excess amount of adhesive 130 squeezes outward, forming flash. The excess adhesive 130 may cure to the sidewalls 108 and create localized stress areas and an undesirable appearance. The flash may affect the longevity of the retreaded tire 141. Methods described herein may remove the flash to reduce the localized stress areas and may improve the appearance of the retreaded tire 141.

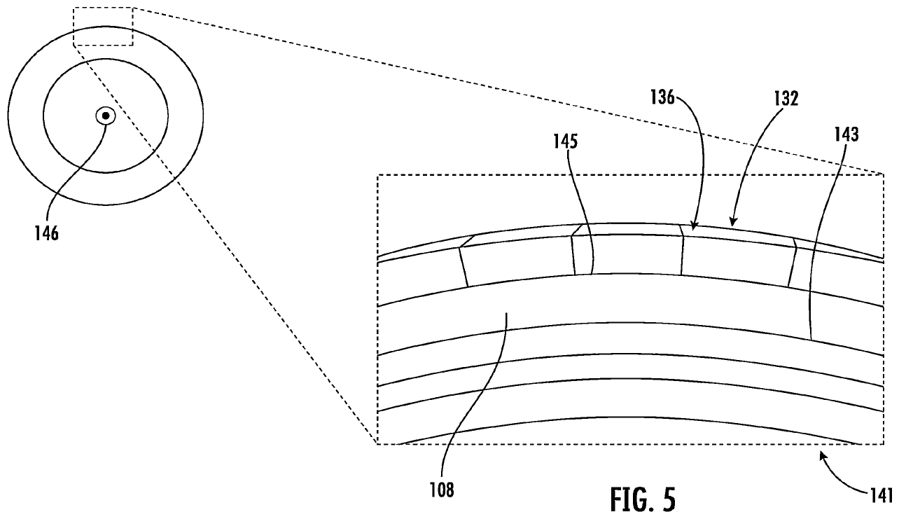

Referring again to FIG. 3, the retreaded tire 141 includes a first bondline 142. The first bondline 142 is interposed between the retread element 132 and the tire casing 100. More specifically, the first bondline 142 is interposed between the buffed tread mounting surface 126 and the adhesive 130. Both sides of the retreaded tire 141 (e.g., the vehicular exterior side and the vehicular interior side) include the first bondline 142. The first bondline 142 is a boundary between the adhesive 130 and the buffed tread mounting surface 126. The first bondline 142 extends across the outer wall 110 between the shoulder areas 124 and extends circumferentially about the retreaded tire 141. The first bondline edge 143 may be visible on the sidewalls 108 after the adhesive 130 and the retread element 132 have been applied to the tire casing 100 (FIG. 5). As used herein, a “bondline edge” is the edge of a cylindrical border (e.g. the first bondline 142, the second bondline 144, etc.) that exists between two portions of the retreaded tire 141.

The retreaded tire 141 further includes a second bondline 144. The second bondline 144 is interposed between the retread element 132 and the tire casing 100. More specifically, the second bondline 144 is interposed between the adhesive 130 and the retread element 132. Both sides of the retreaded tire 141 (e.g., the vehicular exterior side and the vehicular interior side) may include the second bondline 144. The second bondline 144 is a boundary between the adhesive 130 and the retread element 132. The second bondline 144 and extends circumferentially about the retreaded tire 141. The second bondline 144 includes a second bondline edge 145 that may be visible on the sidewalls 108 after the adhesive 130 and the retread element 132 have been applied to the tire case.

Referring now to FIG. 5, a side perspective view of the retreaded tire 141 is shown, according to another example embodiment. In some embodiments, the first bondline edge 143 and the second bondline edge 145 are visible after the retread element 132 has been cured to the tire casing 100 and the retreaded tire 141 is formed. In some embodiments, the flash of the adhesive 130 covers at least one of the first bondline 142 or the second bondline 144. In some embodiments, the first bondline edge 143 and the second bondline edge 145 are visible after the retreaded tire 141 is applied to a rim of a vehicle. The first bondline edge 143 and the second bondline edge 145 may be concentric relative to one another and the first bondline edge 143 and the second bondline edge 145 may be concentric about the axis of rotation 146 of the retreaded tire 141. The first bondline edge 143 and the second bondline edge 145 may be concentric about the axial axis of the tire assembly.

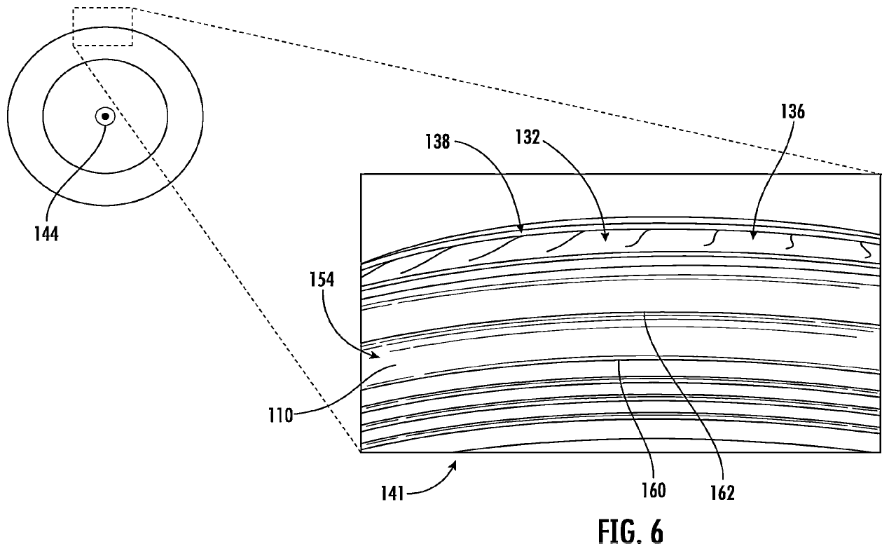

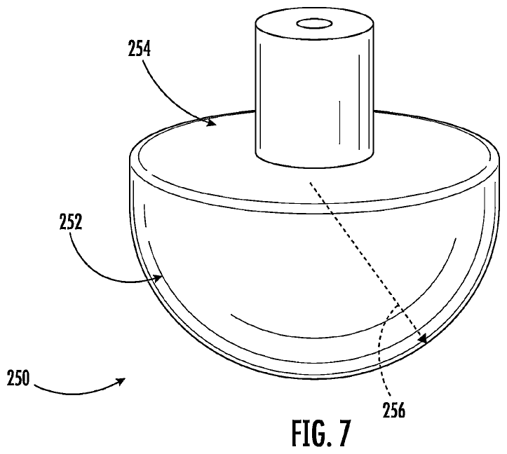

Referring now to FIG. 6, a side perspective view of the retreaded tire 141 is shown. The retreaded tire 141 includes a concave fillet 154. The concave fillet 154 extends contiguously and circumferentially about the sidewall 108 of the retreaded tire 141. In some embodiments, the concave fillet 154 forms a complete loop (e.g. a circle). In some embodiments, the concave filet 154 substantially forms a circle (e.g., forms an imperfect circle, forms a substantially annular shape). The concave fillet 154 may be formed by various cutting process, as described herein. The concave fillet 154 (e.g., concave surface, etc.) is formed on the sidewalls 108 of the retreaded tire 141 by operably engaging the sidewalls 108 with a grinding bit 250 (FIG. 7).

Referring now to FIG. 7, a perspective view of the grinding bit 250 is shown. The grinding bit 250 includes a grinding stone 252 and a coupling body 254 coupled to the grinding stone 252. The grinding stone 252 defines a radius (e.g., radius of curvature), shown as a radius 256. The radius 256 may be between 0 . . . 5 inches and 5 inches, inclusive (e.g., 0.475, 0.5 in., 0.75 in., 1 in., 2 in., 3 in., 4 in., 5 in., 5.25 in., etc.). In some embodiments, the radius 256 of the grinding stone 252 matches a radius of the concave fillet 154. For example, the concave fillet 154 may be formed by grinding away a portion of the sidewall 108 with a single pass of the grinding bit 250 such that the concave fillet 154 has a profile that is substantially the same as the profile of the grinding stone 252. In some embodiments, the concave fillet 154 is formed from two or more passes of the grinding bit 250 such that portions of the concave fillet 154 match the profile of the grinding stone 252, but the concave fillet 154 as a whole does not have a profile that matches the profile of the grinding stone 252. In some embodiments, the grinding stone 252 has a non-circular profile such that different points along the surface of the grinding stone 252 have different curvatures. For example, the grinding stone 252 may have a parabolic profile. In some embodiments, the grinding stone 252 has a non-circular profile such that different points along the surface of the grinding stone have different radii.

The grinding bit 250 may be a rotary grinding bit configured to be rotated at high speeds to remove material. For example, the grinding bit 250 may be operably coupled to a rotary tool and selectively rotated. In some embodiments, the grinding bit 250 is an oscillating grinding bit configured for coupling to an oscillating tool for oscillating back-and-fourth hundreds or thousands of times per minute. In various embodiments, the grinding stone 252 may have a grit (e.g., roughness). The grinding bit 250 is centered on a grinding bit axis 222. In some embodiments, the retreaded tire 141 may be configured to rotate between about 10 rotations per minute (RPM) and about 30 RPM, inclusive (e.g., about 9.5 RPM, about 10 RPM, about 15 RPM, about 20 RPM, about 25 RPM, about 30 RPM, about 31.5 RPM). In other words, the concave fillet 154 is formed while both the tire and the grinding stone are selectively rotated.

In some embodiments, the grinding bit 250 may include a curved blade (e.g., U-shaped blade, etc.) which forms the concave fillet 154. For example, the curved blade may operably engage[s the sidewalls 108 as the retreaded tire 141 rotates and removes a portion of the sidewalls 108 with every rotation until the concave fillet 154 is formed. In other words, the concave fillet 154 may be formed by lathing, where the retreaded tire 141 is rotated while the grinding bit 250 is held stationary.

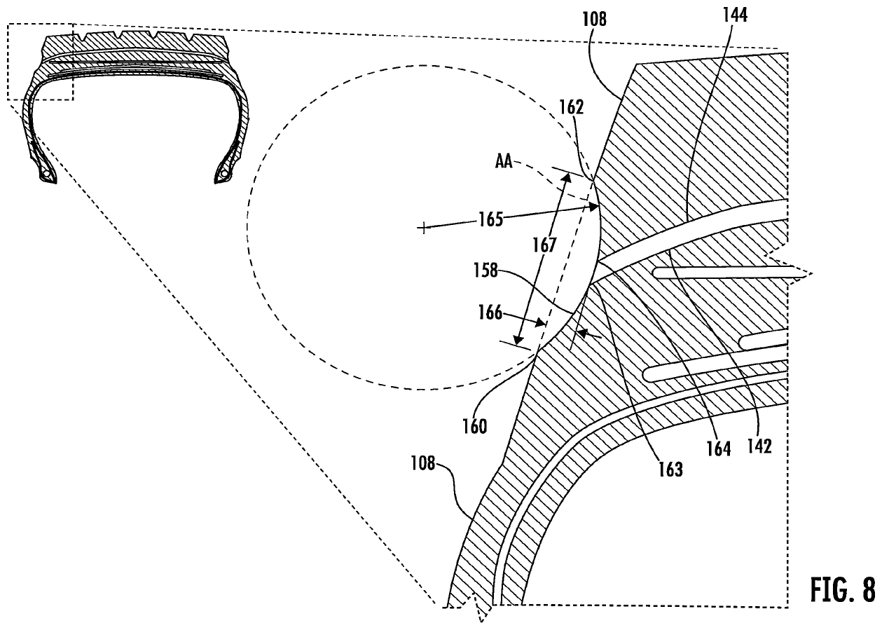

Referring now to FIG. 8, the retreaded tire 141 is shown having the concave fillet 154. The concave fillet 154 includes a fillet surface (e.g., first fillet surface) 158, a first fillet edge (e.g., first end) 160, and a second fillet edge (e.g., second end) 162. The fillet surface 158 extends between the first fillet edge 160 and the second fillet edge 162 and is contiguous with both the first fillet edge 160 and the second fillet edge 162. The first fillet edge 160 defines a border between the concave fillet 154 and the sidewall 108. The first fillet edge 160 is substantially concentric with the axis of rotation 146 of the retreaded tire 141. The first fillet edge 160 extends continuously circumferentially about the sidewall 108 of the retreaded tire 141 and extends radially inward from the retread element front side 136. The second fillet edge 162 defines another border between the concave fillet 154 and the sidewall 108. The second fillet edge 162 is substantially concentric with that axis of rotation 146 of the retreaded tire 141. The second fillet edge 162 extends continuously circumferentially about the sidewall 108 of the retreaded tire 141 and extends radially inward greater than the first fillet edge 160 from the retread element front side 136.

When the grinding bit 250 is engaged with the sidewall 108 and passed along the sidewall 108 of the retreaded tire 141, a portion of the retreaded tire 141 is removed and the fillet surface 158 is formed. In some embodiments, the grinding bit 250 is engaged with the sidewall at position radially inward from the retread element front side 136 a distance between about 0.5 inches and about 6 inches, inclusive (e.g., about 475 in., about 0.5 in., about 1 in., about 2 in., about 3 in., about 4 in., about 5 in., about 6 in., about 6.3 in., etc.). In some embodiments, the first bondline 142 and the second bondline 144 are interposed between the first fillet edge 160 and the second fillet edge 162 such that the fillet surface 158 is contiguous with a post-cut first bondline edge 163 (e.g., the first bondline 142) and a post-cut second bondline edge 164 (e.g., the second bondline 144). In other words, the post-cut first bondline edge 163 and the post-cut second bondline edge 164 are radially outward from the first fillet edge 160 and radially inward from the second fillet edge 162. The post-cut first bondline edge 163 is the edge of the first bondline 142 that may be visible after the fillet surface 158 has been formed. The post-cut second bondline edge 164 is the edge of the second bondline 144 that may be visible after the fillet surface 158 has been formed.

The concave fillet 154 is formed in the sidewall 108, adhesive 130, and retread element 132 of the retreaded tire 141 to remove deformities that may exist following the curing of the retreaded tire 141. In some embodiments, the concave fillet 154 reduces and/or relieves stress risers that could be created from flash. Stress risers are concentrated areas on the sidewalls 108 of the retreaded tire 141 that localize stress in the tire and can cause failure when the retreaded tire 141 is operation. In some embodiments, forming the concave fillet 154 on the sidewalls 108 reduces the time required to assemble the retreaded tire assembly before curing. For example, the adhesive 130 may be applied to the buffed tread mounting surface 126 freely (e.g., quickly and less cautiously) such that the adhesive 130 is disposed on portions of the sidewalls 108. In some embodiments, the application of the adhesive 130 may be automated and less carefully applied to the tire casing 100, as would be expected of application of the adhesive 130 by a human operator. Instead of spending the time to carefully apply the adhesive 130 on the tire casing 100, the adhesive 130 can be applied quickly and less carefully since the aesthetics of the adhesive 130 proximate to the sidewalls 108 (e.g., flash, extra adhesive, bulges, drips, bubbles, etc.) will be removed by the post-cure cutting process, and specifically by the formation of the concave fillet 154.

The concave fillet 154 and fillet surface 158 are defined by a curvature, k, which has units of inverse length. The curvature is defined by the following equation (equation 1):

$$k = \frac{1}{Grinding Bit Radius 252} \qquad ( 1 )$$

where the curvature k of the concave fillet 154 is between about 1.3 inches⁻¹ and about 0.2 in⁻¹, inclusive (e.g., about 1.40 in⁻¹, about 1.3 in⁻¹, about 1.1 in⁻¹, about 0.9 in⁻¹, about 0.7 in⁻¹, about 0.5 in⁻¹, about 0.3 in⁻¹, about 0.2 in⁻¹, about 019 in⁻¹, etc.). In some embodiments, the concave fillet 154 is defined by a radius of curvature of about 0.5 in. to about 1 in., inclusive (e.g., about 0.475 in., about 0.5 in., about 0.6 in., about 0.75 in., about 0.8 in., about 0.9 in., about 1 in., about 1.05 in., etc.).

The concave fillet 154 includes a fillet depth 166. The fillet depth 166 is defined as the greatest measurement between the fillet surface 158 and a line AA that connects the first fillet edge 160 and the second fillet edge 162. The fillet depth 166 is measured perpendicularly from the line AA. The fillet depth 166 may be between about 50% and about 100% of the grinding bit radius, 256 inclusive. In some embodiments, the fillet depth 166 is less than about 25% of the radius of curvature 165. In some embodiments, the fillet depth is between about. 1 inches and 0.4 inches, inclusive (e.g., about 0.095 in., about 0.1 in., about 0.2 in., about 0.3 in., about 0.4 in., about 0.42 in., etc.).

The concave fillet 154 further includes a fillet width 167, measured between the first fillet edge 160 and the second fillet edge 162. In some embodiments, the fillet width 167 is greater than the fillet depth 166. In some embodiments, the fillet depth 166 is equal to the fillet width 167. In some embodiments, the fillet width 167 is approximately equal to the tread thickness 134.

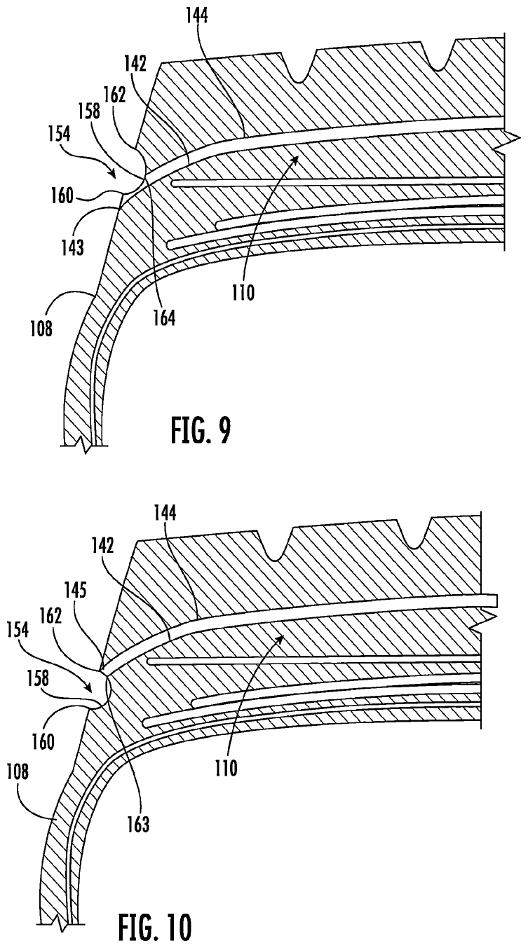

Referring now to FIG. 9, a cross-sectional view of the retreaded tire 141 having the concave fillet 154 is shown, according to another example embodiment. The second fillet edge 162 is positioned between the retread element front side 136 and the first bondline 142, and the first fillet edge 160 is positioned between the first bondline 142 and the second bondline 144. In other words, the second bondline 144 is positioned between the first fillet edge 160 and the second fillet edge 162 such that the post-cut second bondline edge 164 may be visible and the first bondline 142 is radially inward of the second fillet edge 162.

Referring now to FIG. 10, a cross-sectional view of the retreaded tire 141 having the concave fillet 154 is shown, according to another example embodiment. The second fillet edge 162 is positioned between the first bondline 142 and the second bondline 144, and the first fillet edge 160 is positioned between the first bondline 142 and the bead area 120. In other words, the first fillet edge 160 and the second fillet edge 162 are radially inward of the second bondline 144 such that the second bondline edge 145 is visible and the post-cut first bondline edge 163 may be visible.

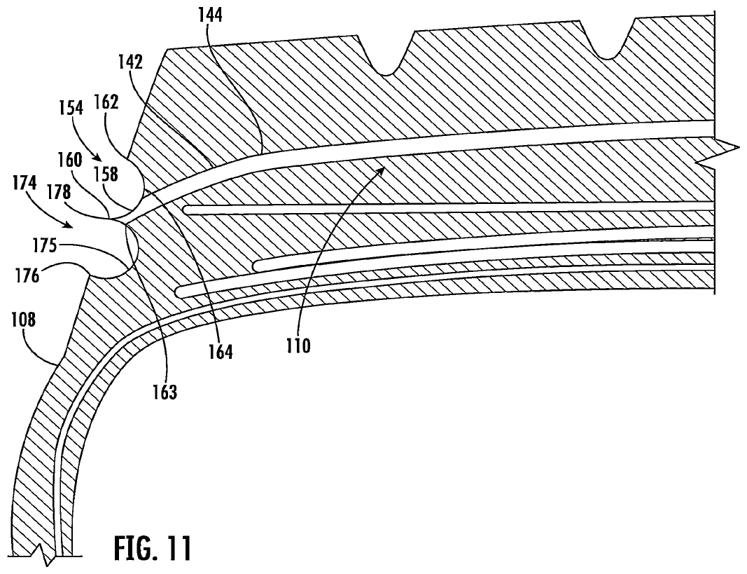

Referring now to FIG. 11, a cross-sectional view of a retreaded tire 141 is shown having a first concave fillet 154 (the concave fillet 154) and a second concave fillet 174. The first concave fillet 154 is positioned radially outward from the second concave fillet 174. The second concave fillet 174 includes a second fillet surface 175, a third fillet edge 176, and a fourth fillet edge 178, where the third fillet edge 176 is radially inward of the fourth fillet edge 178 and the second fillet surface 175 extends between and is contiguous with the third fillet edge 176 and the fourth fillet edge 178.

The second fillet edge 162 is positioned between the retread element front side 136 and the second bondline 144. The first fillet edge 160 is positioned between the first bondline 142 and the second bondline 144. In some embodiments, as shown in FIG. 11, the first fillet edge 160 and the fourth fillet edge 178 meet at a point such that the first fillet surface 158 is contiguous with the second fillet surface 175. In some embodiments, the first fillet edge 160 is positioned radially outward from the fourth fillet edge 178 such that a portion of the sidewall 108 is interposed between the first fillet edge 160 and the fourth fillet edge 178.

The second fillet surface 175 is contiguous with the first bondline 142, but not the second bondline 144. The third fillet edge 176 is positioned radially inward of the first bondline 142. In some embodiments, the first concave fillet 154 and the second concave fillet 174 define substantially the same radius of curvature, as shown in FIG. 11. In some embodiments, the radius of curvature 165 of the first concave fillet 154 is different from a radius of curvature of the second concave fillet 174. For example, the radius of curvature 165 of the first concave fillet 154 may be less than a radius of curvature of the second concave fillet 174. In some embodiments, the radius of curvature 165 of the first concave fillet 154 may be greater than the radius of curvature of the second concave fillet 174.

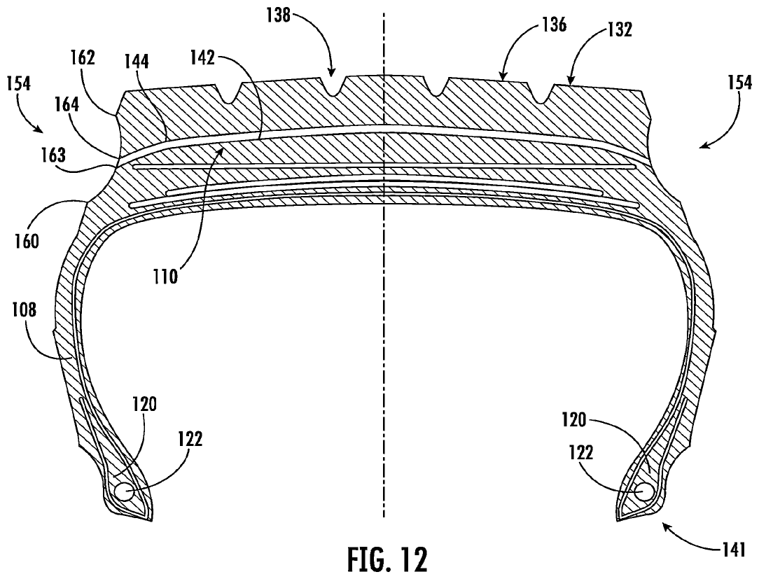

Referring now to FIG. 12, a cross-sectional view of the retreaded tire 141 having the concave fillet 154, according to another example embodiment. The second fillet edge 162 is positioned nearer to the retread element front side 136 than to the second bondline 144. In some embodiments, the second fillet edge 162 is positioned at a distance equal to about 50% of the tread thickness 134 from the retread element front side 136. In some embodiments, the second fillet edge 162 is positioned at a distance of about 25% of the tread thickness 134 from the retread element front side 136. In some embodiments, the tread thickness 134 is equal to (e.g., approximately equal to) the fillet width 167. In some embodiments, the fillet depth 166 is about 25% of the tread thickness 134.

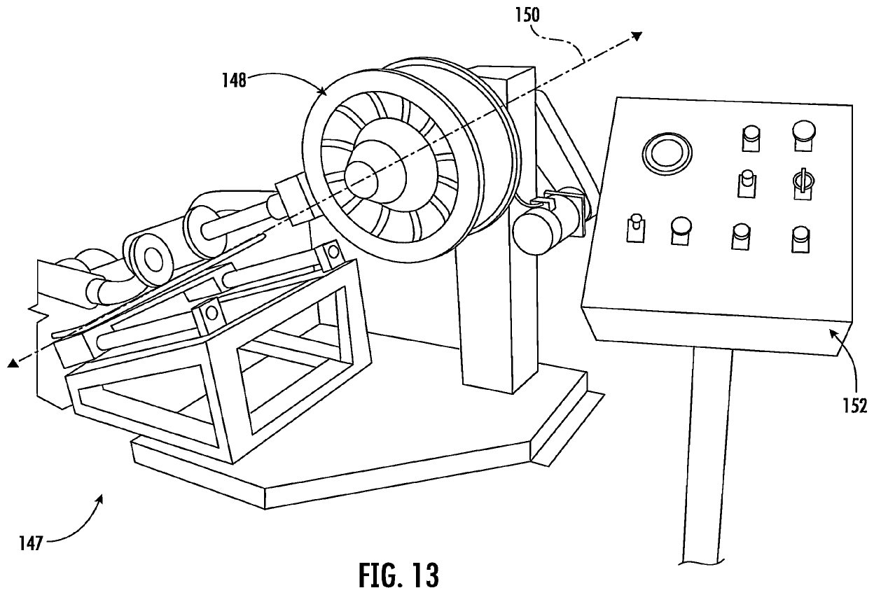

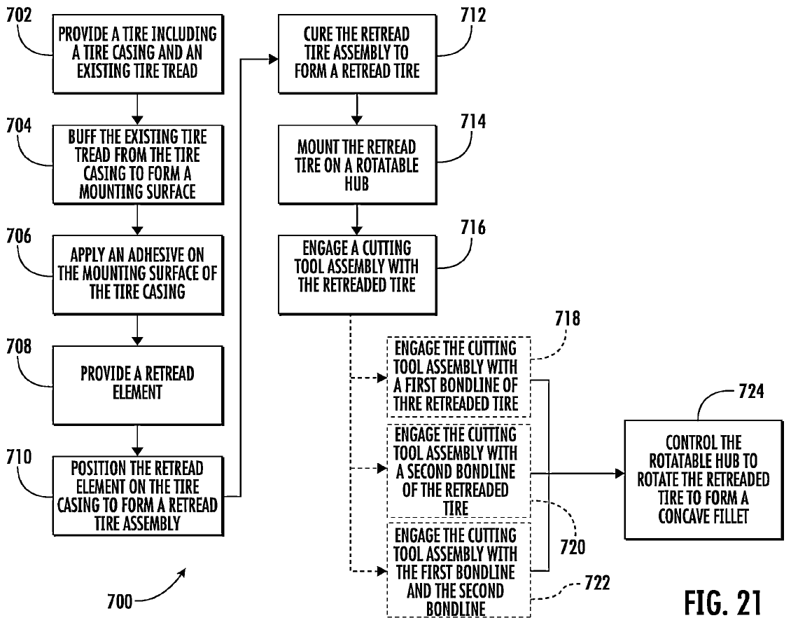

Referring now to FIG. 13, a tire mounting system 147 (e.g., a tire building system, a rim assembly, a tire assembly machine, etc.) is shown, according to an example embodiment. The retreaded tire 141 is mounted to the tire mounting system 147 for a post-cure process, as described herein. The tire mounting system 147 includes a rotatable hub 148 that is rotatable about a hub axis 150. In operation of the tire mounting system 147, the retreaded tire 141 is mounted to the rotatable hub 148 such that the retreaded tire 141 is concentric about and rotatable about the hub axis 150. In some embodiments, the rotatable hub 148 is an expandable rim that includes a plurality of radial rim segments that are selectively expandable to mount tires having various diameters. A controller 152 is communicatively coupled to the rotatable hub 148 and is configured to send instructions to the rotatable hub to rotate the retreaded tire 141 positioned on the rotatable hub 148. After the retreaded tire 141 is mounted on the rotatable hub 148 of the tire mounting system 147, the retreaded tire 141 undergoes a cutting process, shown in FIGS. 21 and 22

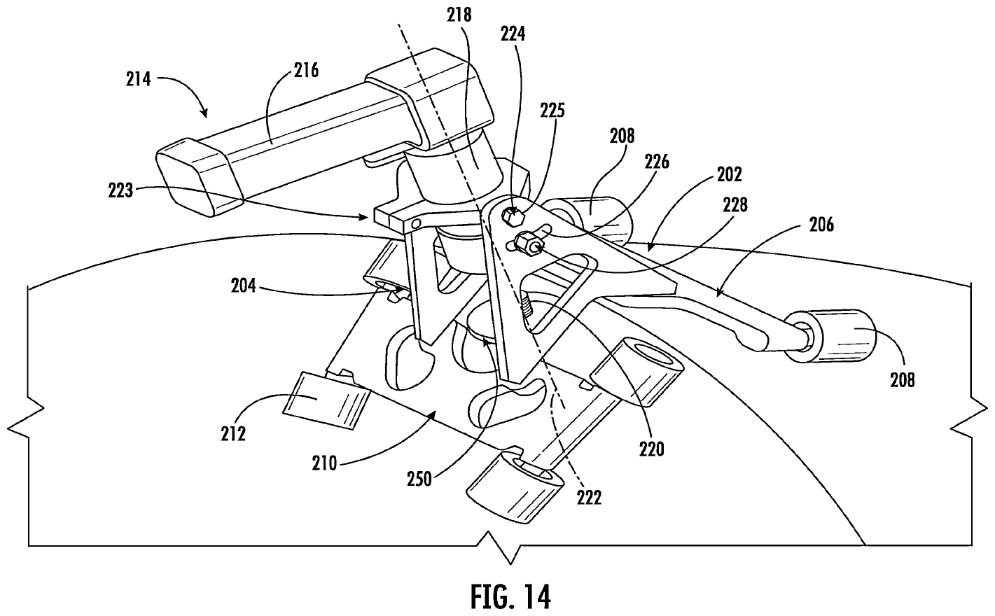

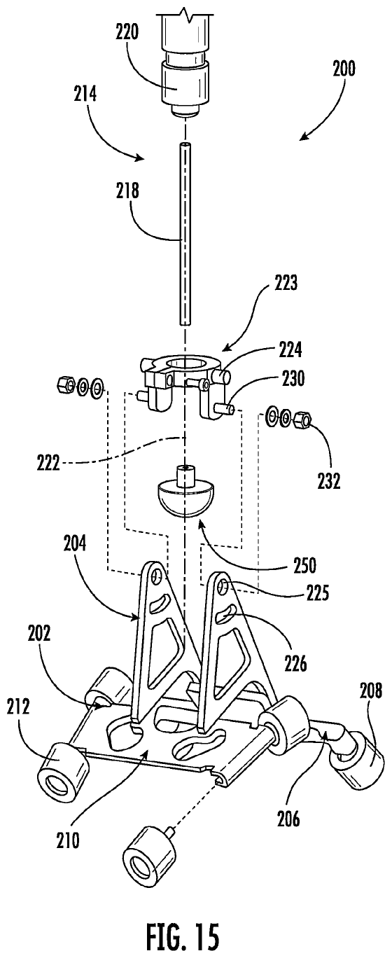

Referring to FIG. 14-15, a cutting tool assembly 200 is shown. The cutting tool assembly 200 is configured to form the concave fillet 154 on the sidewalls 108. In various embodiments, the cutting tool assembly 200 is operated by hand. The cutting tool assembly 200 includes a chassis 202. The chassis 202 includes a main body 204, a first flange 206, and a second flange 210. The first flange 206 is coupled (e.g., attached, fixed, welded, fastened, riveted, adhered, bonded, pinned, etc.) to the main body 204. In various embodiments, the first flange 206 is integrally formed with the main body 204. As utilized herein, two or more elements are “integrally formed” with each when the two or more elements are formed and joined together as part of a single manufacturing process to create a single-piece or unitary construction that cannot be disassembled without an at least partial destruction of the overall component.

The first flange 206 extends in a first direction along the retread element front side 136. In various embodiments, the first direction is substantially in the axial direction. The first flange 206 includes a first set of rollers 208. The first set of rollers 208 is coupled to the first flange 206. The first set of rollers 208 is configured for engaging the retread element front side 136 when the cutting tool assembly 200 is in use to form the concave fillet 154.

The chassis 202 includes a second flange 210 extending in a second direction different from the first direction. When the cutting tool assembly 200 is in use, the second flange 210 extends along the sidewalls 108 of the retreaded tire 141 and maintains a constant position of the grinding bit 250 relative to the retreaded tire 141. In some embodiments, the second flange 210 extends in the radial direction when the cutting tool assembly 200 is in use. The second flange 210 is coupled to the main body 204. In various embodiments, the second flange 210 is integrally formed with the main body 204. The second flange 210 includes a second set of rollers 212. The second set of rollers 212 is rotatably coupled to the second flange 210. In various embodiments, the second set of rollers 212 includes at least two rollers. In various embodiments, the second set of rollers 212 includes at least four rollers. When the cutting tool assembly 200 is used to form the concave fillet 154, the second set of rollers 212 is configured to engage and slide (e.g., roll) along the retreaded tire 141 in the circumferential direction. The first set of rollers 208 and the second set of rollers 212 are configured to translate the cutting tool assembly 200 circumferentially about the retreaded tire 141 relative to the rotational axis of the retreaded tire 141.

The cutting tool assembly 200 further includes an actuator tool 214 coupled to the chassis 202. The actuator tool 214 includes a shaft 218 coupled to the grinding bit 250. The grinding bit 250 is centered on a grinding bit axis 222. In various embodiments, the grinding bit axis 222 extends in the radial direction of the retreaded tire 141 when the cutting tool assembly 200 is operably engaged with the retreaded tire 141. The actuator tool 214 further includes a handle 216. The handle 216 is configured to facilitate movement of the cutting tool assembly 200. The actuator tool 214 also includes an actuator 220 (e.g. rotary actuator, pneumatic rotary actuator, electric rotary actuator, etc.). The actuator 220 is coupled to the handle 216. In various embodiments, the actuator 220 is fluidly coupled to a fluid source. The actuator 220 receives fluid from the fluid source that facilitates rotations of the actuator 220 and the grinding bit 250.

The actuator tool 214 includes the shaft 218. The shaft 218 is operably coupled to the actuator 220 at one end and the shaft 218 is coupled to the grinding bit 250 at the other end. The shaft 218 is selectively coupled to the actuator 220 to facilitate adjustment of the grinding bit 250 toward and away from the chassis 202. This selective coupling of the shaft 218 allows for the grinding bit 250 to be adjusted relative to the actuator 220.

In operation of the cutting tool assembly 200, the retreaded tire 141 is coupled to the rotatable hub 148. In some embodiments, the retreaded tire 141 is fixed such that the retreaded tire 141 does not rotate about the hub axis 150. The cutting tool assembly 200 is positioned on the retreaded tire 141. Specifically, the first set of rollers 208 is positioned on the retread element front side 136 and the second set of rollers 212 is positioned on the sidewalls 108. In some embodiments, a fluid source is connected to the actuator 220. The grinding bit 250 is positioned such that the grinding stone 252 makes contact with the sidewalls 108. The actuator 220 is operated to rotate the actuator 220 and the grinding stone 252 about the grinding bit axis 222. In some embodiments, the actuator 220 is operated with a fluid source that facilitates rotation of the actuator and the grinding stone 252 about the grinding bit axis 222. As the grinding stone 252 rotates, a portion of the sidewalls 108 is removed. The cutting tool assembly 200 is translated circumferentially around the retreaded tire 141 forming the concave fillet 154.

In various embodiments, the retreaded tire 141 is coupled to the rotatable hub 148 and configured to rotate about the hub axis 150. In some embodiments, the controller 152 sends a signal to the rotatable hub 148 to rotate the retreaded tire 141. In some embodiments, the cutting tool assembly 200 engages the retreaded tire 141 and the grinding bit 250 is configured to be stationary relative to the hub axis 150 as the retreaded tire 141 rotates. As the retreaded tire 141 rotates, the grinding stone 252 makes contact with the sidewall 108 and removes portions of the sidewall 108 to form the concave fillet 154.

In various embodiments, the cutting tool assembly 200 includes a cutting tool coupler 223 configured to rotatably and selectively couple the actuator tool 214 to the main body 204. The cutting tool coupler 223 includes a post 224 (e.g., pin, screw, bolt, fastener etc.). The post 224 extends through a pivot bore 225 extending through the main body 204 and allowing rotation of the post 224. The actuator tool 214 is rotatable about the pivot bore 225 such that the actuator tool 214 maybe repositioned relative to the chassis 202. The rotation of the post 224 within the pivot bore 225 facilitates rotation of the cutting tool coupler 223 relative to the chassis 202 and facilitates adjustment of the actuator tool 214 axially forward or axially backward within the chassis 202. For example, the post 224 rotates within the pivot bore 225 to position the grinding bit 250 at different locations relative to the chassis 202. The pivot bore 225 is an aperture in the main body 204. In some embodiments, the post 224 may include threads and be threadingly engaged with the pivot bore 225.

In various embodiments, the cutting tool coupler 223 includes a locking assembly 228 configured to lock the cutting tool coupler 223 in place during operation such that the actuator tool 214 remains stationary relative to the chassis 202. The locking assembly 228 includes a fastener 230 (e.g., pin, screw, bolt, etc.,) and a connector 232 (e.g., nut, wing nut, etc.) (FIG. 15). The main body 204 includes a main body slot 226. The main body slot 226 extends through the main body 204 and circumferentially about the pivot bore 225. The actuator tool 214 is selectively coupled to the main body 204 proximate to the main body slot 226 to prevent the actuator tool 214 from rotating about the pivot bore 225. The main body slot 226 is configured to receive the fastener 230 and allow movement of the fastener 230 along the length of the main body slot 226. The fastener 230 extends through the main body slot 226 and is selectively coupled to the main body 204 via the connector 232 such that the actuator tool 214 is selectively coupled in a fixed position relative to the chassis 202. This allows for adjustment of the grinding bit 250, which results in adjustment of the concave fillet depth 166. For example, the grinding stone 252 may be adjusted so that the concave fillet depth 166 may be between 50% and 100% of the grinding bit radius 256, inclusive. After the actuator tool 214 has been adjusted to a desired location, the connector 232 is coupled to the fastener 230 to lock the actuator tool 214 to the desired location.

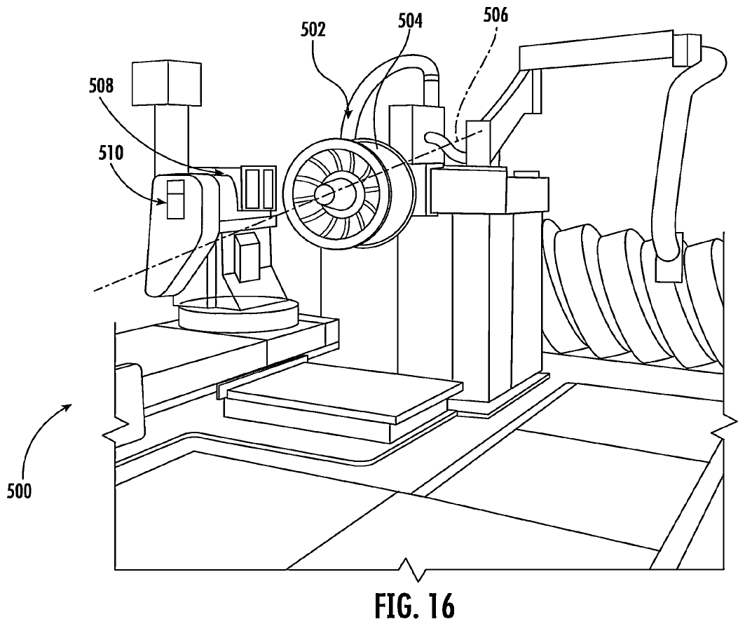

Referring now to FIG. 16, a cutting tool assembly 500 is shown. The cutting tool assembly 500 is configured to form a concave fillet (as shown in FIGS. 8-12) on the sidewalls of a retreaded tire. The cutting tool assembly 500 includes a tire mounting system 502 (e.g., a tire building system, a rim assembly, a tire assembly machine, etc.). The tire mounting system 502 includes a rotatable hub 504. The rotatable hub 504 is configured to receive the retreaded tire. The rotatable hub 504 extends along a rotatable hub center axis 506. The rotatable hub center axis 506 extends axially through the center of the rotatable hub and defines the axis of rotation for the rotatable hub 504. In operation, the retreaded tire 141 is positioned on the rotatable hub 504 such that the retreaded tire 141 is centered on a rotatable hub center axis 506. In some embodiments, the tire mounting system 502 is configured to engage a center aperture of the retreaded tire 141 and orient the retreaded tire 141 on the rotatable hub center axis 506. In some embodiments, the rotatable hub 504 is an expandable rim that includes a plurality of radial pistons (e.g., pneumatically or hydraulically actuated). The plurality of radial pistons may expand to orient the retreaded tire 141 on the rotatable hub center axis 506.

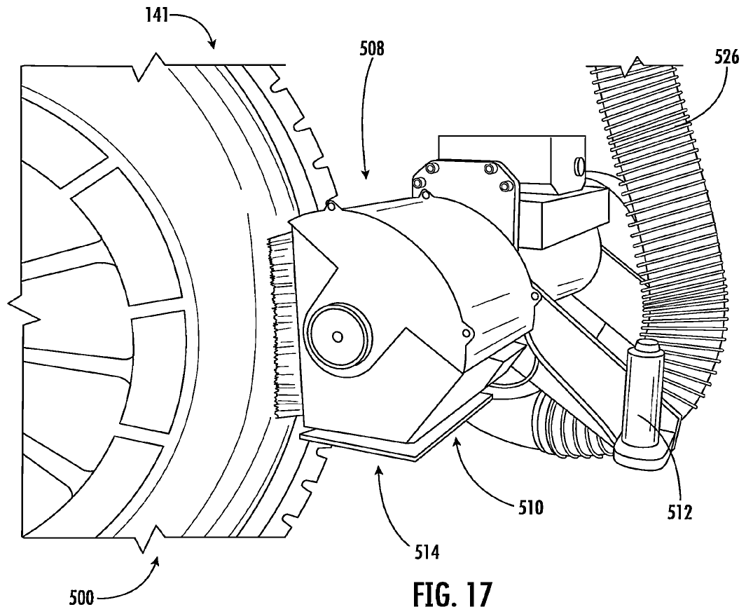

Referring now to FIG. 17, a rear perspective view of a portion of the cutting tool assembly 500 is shown. The cutting tool assembly 500 includes a cutting tool 508. The cutting tool 508 includes a cutting tool body 510. In some embodiments, the cutting tool body 510 remains in a fixed position relative to the rotatable hub 504. In some embodiments, the cutting tool body 510 is coupled to a mount 512. The mount 512 facilitates movement of the cutting tool 508 about the retreaded tire 141. Specifically, the cutting tool body 510 includes a cutting tool hub 514 and the mount 512 is coupled to the cutting tool hub 514. The mount 512 allows for the cutting tool 508 to move freely in an axial direction and a radial direction with respect to the retreaded tire 141.

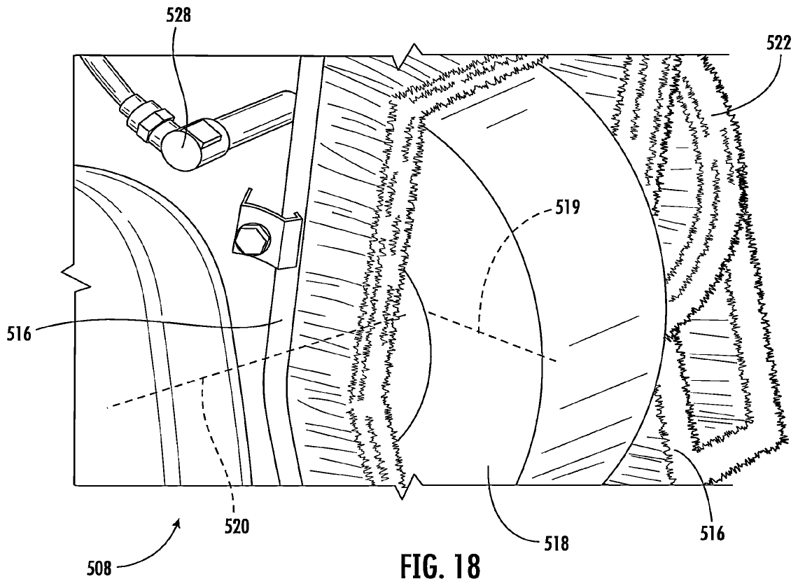

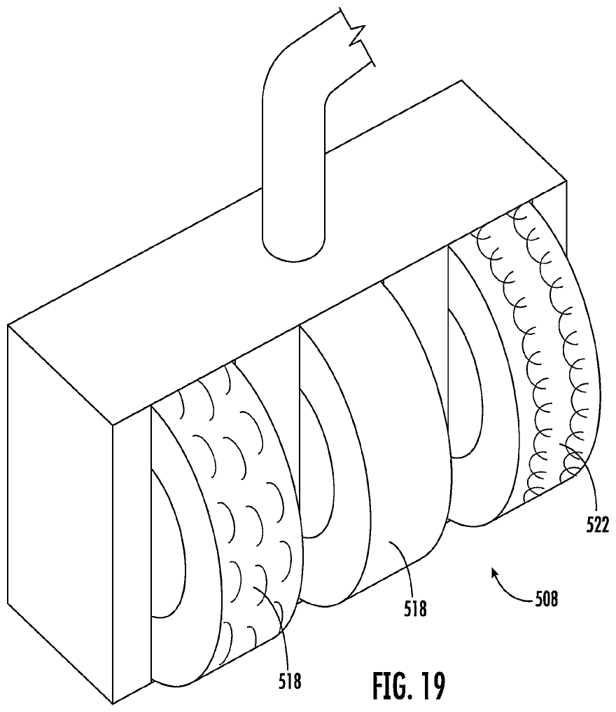

Referring now to FIG. 18 and FIG. 19, a front perspective view of the cutting tool hub 514 is shown. The cutting tool hub 514 includes a cavity 516 that surrounds a portion of a machining wheel (e.g., grinding stone, wire wheel, etc.) 518. The machining wheel 518 is disposed within the cavity 516. The machining wheel 518 includes a radius 519. The radius 519 is in a range of about 0.5 inches and about 5 inches, inclusive (e.g., about 0.71 in., about 0.75 in., about 1 in., about 1.5 in., about 2 in., about 2.5 in., about 3 in., about 3.5 in., about 4 in., about 4.5 in., about 5 in., about 5.25 in., etc.). The machining wheel 518 is operably coupled to an actuator of the cutting tool 508. The actuator is configured to rotate the machining wheel 518 about a wheel axis 520. The wheel axis 520 extends through a center point of the machining wheel 518. In some embodiments, the cutting tool hub 514 includes a second machining wheel, such as a wire brush 522.

The machining wheel 518 is configured to remove a portion of material from the retreaded tire 141 to form the concave fillet 154. The machining wheel 518 may be a grinding stone having a grit (e.g. roughness).

In operation, the cutting tool 508 is operated such that the cutting tool hub 514 is proximate to the sidewalls 108 of the retreaded tire 141. In some embodiments, the cutting tool assembly 500 includes a controller (e.g., the controller 152) communicatively coupled to the cutting tool 508 and configured to control a speed of the machining wheel 518. Specifically, the controller 152 may operate the cutting tool 508 to operably engage the sidewalls of the retreaded tire with the machining wheel 518 such that a portion of the sidewall 108 is removed from the retreaded tire 141. For example, the controller 152 may operate the cutting tool 508 to cause the concave fillet 154 to be formed on a surface of one or more of the sidewalls 108 of the retreaded tire 141 using the machining wheel 518. In this way, material may be removed from the retreaded tire 141 using the controller 152. The machining wheel 518 is rotated via an actuator while being engaged with the sidewall 108 of the retreaded tire 141 to remove a portion of the sidewall 108. The rotatable hub 504 rotates the retreaded tire 141. In some embodiments, the actuator is operated via the controller 152. In some embodiments, the actuator is rotated via a fluid source. In some embodiments, the controller 152 may operate the fluid source supplied to actuator and cause the actuator to rotate.

In some embodiments, the cutting tool assembly 500 includes a vacuum pump 526. The vacuum pump 526 is coupled to the cutting tool hub 514 and is configured to vacuum the removed material from the retreaded tire 141. In some embodiments, the cutting tool assembly 500 includes a cooling source 528 (e.g., fluid source, coolant source, air source, etc.). The cooling source 528 is configured to provide a fluid (e.g., liquid, coolant, air, etc.) to the machining wheel 518. The fluid is configured to reduce the temperature of the machining wheel 518 while the machining wheel 518 is removing a portion of the sidewall 108 from the retreaded tire 141. For example, as the machining wheel 518 is rotating and forming the concave fillet 154, friction between the sidewalls 108 of the retreaded tire 141 and the machining wheel 518 causes heat to generate which may affect and/or damage the machining wheel 518 and the retreaded tire 141, and may affect the forming of the concave fillet 154. The fluid is configured to reduce the heat the produced by this friction.

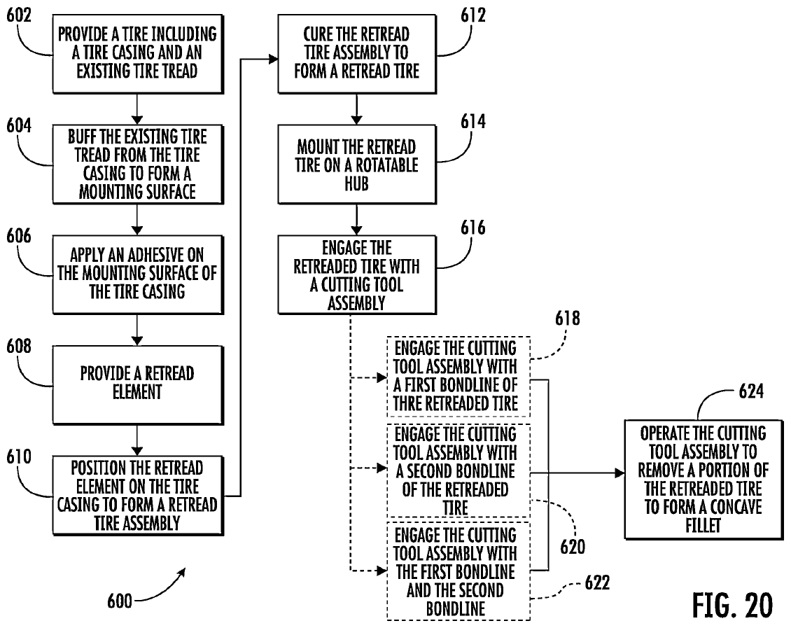

Referring now to FIG. 20, a block diagram of a method 600 for retreading a tire and forming the concave fillet 154 on a retreaded tire 141 is shown. In step 602, a tire is provided. The tire includes the tire casing 100 and an existing tire tread. In step 604, the existing tire tread of the tire is buffed. Specifically, the tire is mounted to a buffing machine. The buffing machine includes a buffer. The buffer makes contact with the existing tread and removes at least a portion of the existing tread. In some embodiments, the tire is rotated as the buffer is removing a portion of the existing tread to form the buffed tread mounting surface 126.

At 606, an adhesive 130 is applied to the mounting surface 126 of the tire casing 100. In some embodiments, the adhesive 130 may be applied such that the tire casing 100 includes more of the adhesive 130 than may be necessary.

At 608, after the adhesive 130 has been applied on the tire casing 100, the retread element 132 is provided. In step 610, the retread element 132 is positioned on the tire casing 100. Specifically, the retread element back side 135 is positioned on the buffed tread mounting surface 126 on the adhesive 130 to form a retread tire assembly.

In step 612, the retread tire assembly is cured to form the retreaded tire 141. To cure the retread tire assembly, in some embodiments, the retread tire assembly is placed in an envelope. The envelope is configured to retain the retread tire assembly and prevent the retread element 132 from shifting during the curing process. The envelope including the retread tire assembly is placed in a curing chamber (e.g., autoclave, etc.). The curing chamber facilitates curing (e.g., vulcanization) of the adhesive 130 so that the retread element 132 couples to the buffed tread mounting surface 126 and the tire casing 100 to form the retreaded tire 141. In various embodiments, during the curing process, excess adhesive 130 may vulcanize on the retreaded tire sidewalls 108. This may cause stress risers to form which may lead to tire failure during operation.

At step 614, the retreaded tire is mounted on a tire mounting system 147. In some embodiments, the retreaded tire 141 is mounted on the rotatable hub 148. The rotatable hub 148 may hold the retreaded tire 141 in a fixed position such that the retreaded tire 141 is prevented from rotating.

At 616, a cutting tool assembly (e.g., the cutting tool assembly 200, the cutting tool assembly 500) is engaged with the retreaded tire 141. Specifically, the cutting tool assembly is positioned such that a grinding bit (e.g., the grinding bit 250, the machining wheel 518) on the cutting tool assembly makes contact with the sidewalls 108 of the retreaded tire 141.

At step 618, the grinding bit may be adjusted relative to the chassis 202 to engage the first bondline 142. The first bondline 142 is a visible line that extends circumferentially around the sidewalls 108 of the retreaded tire 141. The first bondline 142 forms between the buffed tread mounting surface 126 and the adhesive 130.

At step 620, the cutting tool assembly engages the second bondline 144. The second bondline 144 is a visible line that extends circumferentially around the sidewalls 108 of the retreaded tire 141. The second bondline 144 is interposed between the retread element 132 and the adhesive 130.

At step 622, the cutting tool assembly engages both the first bondline 142 and the second bondline 144.

At step 624, the cutting tool assembly is operated to remove a portion of the sidewall 108 to form the concave fillet 154 in the sidewalls 108 of the retreaded tire 141. As the grinding bit is rotating and removing a portion of the sidewall 108 from the retreaded tire 141, the cutting tool assembly is translated circumferentially around the sidewalls 108 so that the concave fillet 154 is formed circumferentially around the sidewalls 108. If the cutting tool assembly is engaged with the first bondline 142 as described in step 618, the concave fillet 154 is formed such that the fillet surface 158 is contiguous with the first bondline 142, but is not contiguous with the second bondline 144. If the cutting tool assembly is engaged with the second bondline 144 as described in step 620, the concave fillet 154 is formed such that the fillet surface 158 is contiguous with the second bondline 144, but not contiguous with the first bondline 142. If the cutting tool assembly is engaged with the first bondline 142 and the second bondline 144 as described in step 622, the concave fillet 154 is formed such that the fillet surface 158 is contiguous with both the first bondline 142 and the second bondline 144.

Referring now to FIG. 21, a block diagram of a method 700 for retreading a tire and forming the concave fillet 154 on the retreaded tire 141 is shown. In step 702, a tire is provided. The tire includes the tire casing 100 and an existing tire tread. In step 704, the existing tire tread of the tire is buffed. Specifically, the tire is mounted to a buffing machine. The buffing machine includes a buffer. The buffer makes contact with the existing tread and removes a portion of the existing tread. Here, the tire is rotating as the buffer is removing a portion of the existing tread so that the buffed tread mounting surface 126 can be created. The buffed tread mounting surface 126 is a uniform surface on the tire casing 100.

At step 706, the adhesive 130 is applied to the buffed tread mounting surface 126. In some embodiments, the adhesive 130 may be applied such that the tire includes more adhesive 130 than may be necessary.

At 708, after the adhesive 130 has been applied on the tire casing 100, the retread element 132 is provided.

At step 710, the retread element 132 is positioned on the tire casing 100 to form a retread tire assembly. Specifically, the retread element back side 135 is positioned on the buffed tread mounting surface 126 and on the adhesive 130. The continuous profile of the retread element back side 135 conforms to the buffed tread mounting surface 126 and conforms to the adhesive 130.

At step 712, the retread tire assembly is cured to form the retreaded tire 141. To cure the retread tire assembly, in some embodiments, the retread tire assembly is placed in an envelope. The envelope is configured to retain the retread tire assembly and prevent the retread element 132 from shifting during the curing process. The envelope including the retread tire assembly is placed in a curing chamber (e.g., autoclave, etc.). The curing chamber allows for the adhesive 130 to vulcanize such that the retread element 132 is coupled to the tire casing 100 to form the retreaded tire 141. In various embodiments, during the curing process, excess adhesive may vulcanize on the sidewalls 108 of the retreaded tire 141. This may cause stress risers to form which may lead to failure during operation. To remove these stress risers, the concave fillet 154 is formed in the sidewall 108.

At 714, the retreaded tire 141 is mounted on a rotatable hub, such as the rotatable hub 148.

At 716, a cutting tool assembly is engaged with the retreaded tire 141. Specifically, the cutting tool assembly is positioned such that a grinding bit on the cutting tool assembly makes contact with the sidewalls 108 of the retreaded tire 141. In some embodiments, the cutting tool assembly may be a portable device that is operated by hand. In some embodiments, the cutting tool assembly may be an automatic cutting tool device that is controlled by a controller.

After the cutting tool assembly engages with the retreaded tire 141, in some embodiments, the method 700 goes to step 718 where the grinding bit may be adjusted in a radial direction to engage with the first bondline 142. The first bondline 142 is a visible line that extends circumferentially around the sidewalls 108 of the retreaded tire 141. The first bondline 142 forms between the buffed tread mounting surface 126 and the adhesive 130. In some embodiments, the method 700 may proceed to step 720. In step 720, the cutting tool assembly engages with the second bondline 144. The second bondline 144 is a visible line that extends circumferentially around the sidewalls 108 of the retreaded tire 141. The second bondline 144 is interposed between the retread element 132 and the adhesive 130. In some embodiments, the method 700 proceeds to step 722. In step 722, the cutting tool assembly engages with the first bondline 142 and the second bondline 144.

At step 724, a controller controls the rotatable hub 148 to rotate the retreaded tire 141 circumferentially about a rotatable hub center axis. Further, an actuator is controlled to cause the grinding bit to rotate about a grinding bit axis. Here, the cutting tool assembly is in a stationary position and makes contact with the sidewalls. As the grinding bit rotates about the grinding bit axis, the rotatable hub rotates the retreaded tire and the concave fillet is formed on the retreaded tire.

If the cutting tool assembly engaged with the first bondline 142 as described in step 718, the concave fillet 154 is formed over the first bondline 142. If the cutting tool assembly engaged with the second bondline 144 as described in step 720, the concave fillet 154 is formed over the second bondline 144. If the cutting tool assembly engaged with the first bondline 142 and the second bondline 144, as described in step 722, the concave fillet 154 is formed over the first bondline 142, the sidewalls 108 between the first bondline 142 and the second bondline 144, and the second bondline 144.

As utilized herein with respect to numerical ranges, the terms “about,” “approximately,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “for example” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled to one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “inward,” “outward,”) are merely used to describe the orientation of various elements in the FIGURES. It should be noted that the orientation of various elements may differ according to other exemplary embodiments, and that such variations are intended to be encompassed by the present disclosure.

What is claimed is:

1. A method of forming a retreaded tire, the method comprising:
coupling a retread element to a tire casing to form a retreaded tire having a tread surface; and
machining a sidewall of the retreaded tire, wherein the machining comprises:
removing a portion of the sidewall to form a concave fillet in the sidewall, the concave fillet positioned radially inward from the tread surface.

2. The method of claim 1, wherein:
the retreaded tire further comprises a first bondline extending circumferentially about the retreaded tire, the first bondline positioned between the retread element and the tire casing; and
machining the sidewall of the retreaded tire further comprises:
engaging the first bondline with a grinding bit; and
removing the portion of the sidewall comprising the first bondline to form the concave fillet in the sidewall.

3. The method of claim 2, wherein:
the concave fillet includes a first fillet end, a second fillet end positioned radially inward from the first fillet end, and a fillet surface extending between the first fillet end and the second fillet end, and
the concave fillet is formed such that the first fillet end is positioned between the tread surface and the first bondline.

4. The method of claim 3, wherein the concave fillet is formed such that the first fillet end is positioned between about 0.5 and about 1.5 inches, inclusive, radially inward from the tread surface.

5. The method of claim 1, wherein the concave fillet, has a radius of curvature between about 0.75 and about 5 inches, inclusive.

6. The method of claim 1, further comprising:
positioning the retreaded tire on a rotatable hub; and
rotating the retreaded tire via the rotatable hub while maintaining a grinding bit in a stationary position relative to an axis of rotation of the rotatable hub, the grinding bit configured to remove the portion of the sidewall to form the concave fillet.

7. The method of claim 1, wherein a grinding bit is operably coupled to an actuator configured to rotate the grinding bit about a grinding bit axis, the method further comprising:
maintaining the retreaded tire in a stationary position such that the retreaded tire does not rotate about an axis of rotation of the retreaded tire;
engaging the grinding bit with the sidewall of the retreaded tire; and
translating the grinding bit and the actuator circumferentially about the retreaded tire relative to a rotational axis of the retreaded tire.

8. The method of claim 1, further comprising:
positioning a cushion gum on the tire casing;
positioning the retread element on the cushion gum such that the cushion gum is interposed between the retread element and the tire casing; and
curing the cushion gum to form the retreaded tire, the retreaded tire having a first bondline positioned between the retread element and the cushion gum, and a second bondline positioned between the cushion gum and the tire casing, the second bondline being positioned radially inward of the first bondline,
wherein machining the sidewall of the retreaded tire further comprises removing a portion of the tire casing, removing a portion of the cushion gum, and removing a portion of the retread element.

9. The method of claim 8, wherein removing a portion of the sidewall includes removing a portion of the first bondline and removing a portion of the second bondline.

10. The method of claim 8, wherein
the concave fillet includes a first fillet end, a second fillet end positioned radially inward from the first fillet end, and a fillet surface extending between the first fillet end and the second fillet end, the fillet surface being contiguous with at least one of the first bondline or the second bondline.

11. The method of claim 10, wherein the first fillet end is positioned between the tread surface and the first bondline, and the second fillet end is positioned radially inward of the second bondline.

12. The method of claim 10, wherein the first fillet end is positioned between about 0.5 and about 1.5 inches, inclusive, radially inward from the tread surface.

13. A cutting tool assembly comprising:
a chassis comprising:
a main body;
a first flange coupled to the main body and extending in a first direction, the first flange having a first roller configured for engaging a tread surface; and
a second flange coupled to the main body and extending in a second direction different from the first direction, the second flange having a second roller configured for engaging a sidewall of a tire; and
an tool coupled to the chassis, the tool comprising:
a handle;
an actuator; and
a grinding bit operably coupled to the actuator, the grinding bit configured to remove a portion of the sidewall to form a concave fillet.

14. The cutting tool assembly of claim 13, wherein the main body further comprises:
a pivot bore extending through the main body; and
a slot extending through the main body and extending circumferentially about the pivot bore,
wherein the actuator tool is rotatable about the pivot bore and selectively coupled to the main body.

15. The cutting tool assembly of claim 13 further comprising a cutting tool coupler coupled to the actuator, the cutting tool coupler comprising:
a post extending through the pivot bore; and
a fastener extending through the slot and movable within the slot, the fastener selectively coupled to the main body to fix the cutting tool coupler in a position relative to the chassis.

16. The cutting tool assembly of claim 15, wherein the actuator is selectively coupled to the cutting tool coupler to facilitate adjustment of the actuator relative to the cutting tool coupler and relative to the chassis.

17. A method of forming a retreaded tire, the method comprising;
providing a tire casing having a casing profile;
providing a retread element having a back side and a front side, the front side having a tread surface;
aligning the retread element on the tire casing to produce a retreaded tire assembly;
curing the retreaded tire assembly such that the back side is coupled to the tire casing to form a retreaded tire; and
machining a sidewall of the retreaded tire to remove a portion of the retreaded tire to form a concave filet contiguously and circumferentially about the sidewall of the retreaded tire.

18. The method of claim 17, wherein:
the retread element comprises a tread span between the front side and the back side;
the concave fillet comprises a first fillet end and a second fillet end separated radially by a fillet width, the first fillet end being radially inward of the second fillet end;
the second fillet end is positioned radially inward of the tread surface by a third distance, the third distance being less than the tread span; and
the first fillet end is positioned radially inward of the tread surface by a fourth distance, the fourth distance being greater than the tread span.

19. The method of claim 17, wherein machining the sidewall of the retreaded tire includes engaging the sidewall of the retreaded tire radially inward of the retread element with a grinding bit and removing a portion of the retreaded tire to form the concave fillet.

20. The method of claim 19, wherein the retread element is cured to the tire casing using a cushion gum, and wherein the portion of the retreaded tire comprises each of the tire casing, the cushion gum, and the retread element.
